(19) United States
(12) Patent Application Publication
(10) Pub. No.: US 2015/0021835 A1
(43) Pub. Date: Jan. 22, 2015

(54) Use Of Biodegradable Plastics Films In Processes For Producing Fiber-Reinforced Plastics By Means Of Vacuum Infusion

(71) Applicant: BASF Coatings GmbH, Münster (DE)

(72) Inventor: Martin Kaune, Oldenburg (DE)

(21) Appl. No.: 14/368,942

(22) PCT Filed: Dec. 28, 2012
(86) PCT No.: PCT/EP2012/077053

§ 371 Date: Jun. 26, 2014

Related U.S. Application Data
(60) Provisional application No. 61/581,140, filed on Dec. 29, 2011.

(30) Foreign Application Priority Data
Dec. 29, 2011 (EP) 11196091.0

(51) Int. Cl. B29C 70/48

(52) U.S. Cl. CPC B29C 70/48; B29K 2063/00
USPC 264/553

(57) ABSTRACT

The present invention relates to the use of biodegradable plastics films as vacuum films in processes for producing fiber-reinforced plastics or fiber-reinforced plastics components by means of vacuum infusion. The invention further relates to a process for producing fiber-reinforced plastics or fiber-reinforced plastics components, in particular fiber-reinforced rotor blades for windpower systems, by means of vacuum infusion with use of biodegradable films.

The present invention relates to the use of plastics films in processes for producing fiber-reinforced plastics by means of vacuum infusion, and also to corresponding processes with use of such plastics films.

Vacuum infusion processes are currently used in producing large fiber composite components, for example during production of rotor blades for windpower systems.

The vacuum infusion process, providing what is known as a sandwich-type structure, has now become a very widely used method for producing rotor blades. The largest and most modern blades are composed of adhesive-bonded mats of glass fiber and of carbon fiber, with epoxy resin injected in vacuo into these mats. This high-tech method of construction provides the necessary exceptional stability and flexibility, but at the same time keeps the blades thin and light.

The principle of blade manufacture functions as described below. First, the mold composed of two heatable half shells is treated with release agent. The shell is then optionally coated with an in-mold gelcoat, and, once this has hardened, the mold is provided with glassfiber mats and with other reinforcing material, for example balsa wood and PU foams. Specialized hoses are then used, from which the mixture made of epoxy resin, hardeners, and additives then flows. There then follows a plastics film, which provides an airtight seal around the entire arrangement. Two layers of this are laid here in order to ensure airtightness. In the next step, all of the air between mold and film is extracted. The resultant vacuum sucks the liquid resin/hardener mixture through the hoses into the mold and saturates the reinforcing material. This process has the advantage of uniform saturation of the fibers and therefore high quality of the components produced, and also reproducibility of the same. A conditioning step is mostly then first carried out to heat the half shells to about 40 to 50° C. in order to solidify the component to the extent that it can safely be transported. After this step, the vacuum film, infusion aids, and the like are then removed, and the rotor blade halves are then cured at about 70 degrees Celsius. The adhesive bonding of the two halves of the blade then follows. Prior to the multistage coating process, the surface of the blade is abraded to remove the release agent. A gelcoat, applied in the first step to the rotor blade, protects it from environmental effects, such as moisture and light. Small uneven areas on the surface are leveled by the surface filler. The coating process for the blades finally provides wear-resistant edge protection, and also topcoat.

The plastics film which is used prior to application of the vacuum and which serves to provide the airtight seal prior to suction-assisted input of the resin/hardener mixture can be used only once because of the nature of the process, and then requires disposal. These films, used in the form of two layers, are generally composed of polyamide.

Production of very large components, such as the abovementioned rotor blades for wind energy systems, sometimes requires several hundred square meters of plastics film. Disposal of the films generates enormous costs and enormous amounts of waste, and there is a need to reduce these with a simultaneous improvement in energy balance.

The object of the present invention was inter alia to overcome the abovementioned disadvantages associated with the use of the films used hitherto.

Surprisingly, biodegradable plastics films which comply with the stringent requirements of the obligatory European standard for biodegradable plastics (EN 13432) have proven suitable for replacing the polyamide-based films used hitherto. This was particularly surprising because these films usually have a tendency toward thermal decomposition at the elevated curing temperatures of about 50° C. The Ecoflex® films from BASF SE, Ludwigshafen, Germany have proven to have particularly good suitability.

The significant main properties, alongside the temperature resistance, consist in the airtightness and elasticity of the films, the aim also being to compensate possible stresses during vacuum forming. The films can also be optimized additionally through an appropriate surface treatment, e.g. a nanoscale antiadhesive plasma layer.

The present invention therefore provides the use of biodegradable plastics films as vacuum films in processes for producing fiber-reinforced plastics by means of vacuum infusion.

This use is termed inventive use below.

The invention also provides a process for producing fiber-reinforced plastics or fiber-reinforced plastics components by means of vacuum infusion, by (a) optionally treating a heatable mold with a release agent, (b) introducing a fiber material and optionally other reinforcing material into the mold, (c) placing one or more hoses which serve for the subsequent input of a liquid mixture encompassing at least one resin and at least one hardener reactive toward the resin, (d) applying a plastics film which permits airtight sealing of the mold, and (e) extracting, for example by pumping, the air between mold and plastics film, whereupon the resultant vacuum sucks the liquid mixture through the hoses into the mold and the fiber material and the optionally present other reinforcing materials are saturated, and then (f) curing the liquid mixture to give the fiber-reinforced plastic, characterized in that the plastics film used in step (d) is a biodegradable plastics film.

This process is termed inventive process below.

The biodegradable plastics films used in the inventive use or in the inventive process preferably involve plastics films based on aliphatic-aromatic copolyesters.

Suitable copolyesters are those obtainable with use of short-chain aliphatic diols having from 2 to 8 carbon atoms, in particular 4 carbon atoms, for example 1,4-butanediol, or of aliphatic dicarboxylic acids having from 3 to 8 carbon atoms, or of their anhydrides, esters or halides, for example adipic acid, and of aromatic dicarboxylic acids, or of their anhydrides, esters, or halides, for example terephthalic acid, terephthalic anhydride, or terephthalic ester. The production of these copolyesters can use not only the abovementioned aliphatic diols, aliphatic dicarboxylic acids, and aromatic dicarboxylic acids, but also higher-functionality monomers, such as in particular triols, tetraols, and tricarboxylic acids or tetracarboxylic acids, where these lead to branched polymer structures. Examples of suitable polyols are trimethylolpropane (TMP) and pentaerythritol.

Particularly suitable copolyesters are by way of example the aliphatic-aromatic copolyesters described by Witt et al. in the journal Chemosphere 44 (2001) 289-299. Copolyesters of this type are obtainable by way of example with trademark Ecoflex® from BASF SE (Ludwigshafen, DE).

A particular additional challenge was to find biodegradable film materials of this type which exhibit not only retention of vacuum in the production of large workpieces, such as rotor blades for windpower systems (which can have a length of 80 m or more) but also excellent compatibility with the resin system and hardener system used (usually an epoxy resin-amine hardener system). Specifically the abovementioned aliphatic-aromatic copolyesters have proven to have very particularly good suitability for these purposes.

The biodegradable films can be used directly. However, it can also be advantageous, e.g. for relatively high infusion temperatures or relatively high temperatures during the first curing step, to pretreat the film physically, for example by using low-pressure plasma technology, in order to facilitate release from the workpiece after curing.

The liquid mixture input under suction in step (e) of the process and comprising resin and hardener is preferably temperature-controlled prior to input under suction. In the case of epoxy resin-amine hardener mixtures this temperature (infusion temperature) is preferably from 35 to 45° C.

The curing step (f) preferably takes place in a plurality of stages, particularly preferably in two stages. In a first stage, precuring takes place preferably at a temperature which is from 5 to 15° C. above the infusion temperature. In the case of epoxy resin-amine hardener mixtures this temperature is typically in the range from 40 to 60° C., preferably from 45 to 55° C. After this precuring, the duration of which is usually a plurality of hours, for example from 2 to 8 hours, preferably from 4 to 6 hours, the plastics film applied in step (d) is removed. This preferably takes place via peeling of the plastics film. In a second stage, the precured fiber-reinforced plastic is then cured completely. The complete curing usually takes place at a temperature which is from 20 to 40° C., preferably from 25 to 35° C., above the infusion temperature. In the case of epoxy resin-amine hardener mixtures this temperature is typically in the range from 60 to 80° C., preferably from 65 to 75° C. The temperature here for the second curing stage (also termed heating stage) is higher than that for the first stage.

It is preferable that the temperature for conduct of the second stage is at least 5° C., particularly preferably at least 10° C., and very particularly preferably at least 15° C., higher than for conduct of the first stage. The curing time in this step is preferably from 5 to 15 hours, particularly preferably from 7 to 12 hours.

The molds for use in the inventive process are usually composed of glassfiber-reinforced plastic, carbon-fiber-reinforced plastic or steel. Release agent used if necessary in step (a) of the inventive process usually comprises silicone-containing, water-thinnable or solvent-containing release agents, e.g. Frekote NC 55 (solvent-containing; Henkel KGaA, Dusseldorf, Germany) and Mono Coat 1001 W (water-thinnable; ChemTrend, Maisach, Germany).

The fiber materials used for producing the fiber-reinforced plastics preferably involve glass fibers or carbon fibers, for example in the form of individual fibers, but in particular in the form of glassfiber mats or glassfiber bundles and carbon fiber mats or carbon fiber bundles. Other suitable reinforcing materials are balsa wood and polyurethane foams, and also woven metal fabric.

Examples of vacuum hoses that can be used are pressure- and vacuum-resistant polyethylene hoses.

The plastics constituent of the fiber-reinforced plastic usually comprises an epoxy resin or a polyester resin, and also hardeners (crosslinking agents) which are suitable for the resins and which react chemically with the resins.

Epoxy resins are preferably cured by means of amine hardeners. Examples of epoxy resin-amine hardener systems which can be used in vacuum infusion technology are described inter alia in WO 2010/010048 A1. The epoxy equivalent weight of particularly preferred epoxy resins is from 150 to 200 g/equivalent, preferably from 160 to 190 g/equivalent. Particularly suitable amine hardeners for abovementioned epoxy resins are those having an amine number from 350 to 750 mg KOH/g, very particularly preferably having an amine number from 400 to 700 mg KOH/g, and in particular having an amine number from 450 to 650 mg KOH/g. The ratio of the epoxy resin to the amine hardener in the abovementioned instances is preferably from 100:25 to 100:35 (m/m). Resin-hardener systems of this type can also comprise other additives, for example flow aids, antifoams, and deaerators, and also surface additives. The curing of the epoxy resin-amine hardener systems in step (f) of the inventive process usually takes place at temperatures of from 50 to 90° C., preferably from 60 to 80° C., particularly preferably from 65 to 75° C. An epoxy resin system which has excellent suitability for use in the inventive process is obtainable as Baxxodur® (BASF SE, Ludwigshafen, DE).

Polyester resins are usually cured by means of peroxidic polymerization initiators. Examples of polyester resin systems which can be used in vacuum infusion technology are disclosed inter alia in the appropriate technical data sheets from BUFA (Rastede, Germany). Resin systems of this type can also comprise other additives, for example flow aids, antioxidants, and also antifoam additives and surface additives. The curing of the polyester resin systems in step (f) of the inventive process usually takes place at temperatures of from 50 to 90° C., preferably from 60 to 80° C., particularly preferably from 65 to 75° C.

The inventive process is usually followed by coating of the cured and optionally conditioned workpiece. Any release agent used is removed, for example via abrasion, prior to the coating process.

In the case of production of rotor blades for wind energy systems, the inventive process first produces two workpieces in a mold composed of two heatable half shells or in two molds, these then being adhesive-bonded to one another prior to the coating process. The adhesive bonding here normally takes place by way of connecting fillets.

The inventive process can in principle produce workpieces made of fiber-reinforced plastics of any desired shape and size, in an efficient and environmentally compatible manner. The inventive process can in particular produce workpieces which are large and/or of complex shape, examples being rotor blades, especially those for windpower systems, aircraft parts or helicopter parts, or else add-on parts for automobiles and mass-produced components, e.g. engine hood and wheel surround.

Examples will be used below for further explanation of the invention.

### EXAMPLES

### Example 1

Production of a glassfiber-reinforced plastics sheet (GRP sheet) by the vacuum infusion process, and use of Ecoflex® film to produce the vacuum bag.

### Material:

Infusion resin: RIM 135 (Momentive) (100 parts by weight)
Infusion hardener: RIM 137i-134 (Momentive) (30 parts by weight)
Glass scrim: Biaxial layer, OFC, 821 g/m², 635 mm
Number of glass scrims: 8
Release agents: Mono Coat 1001 W (water-thinnable; ChemTrend, Maisach, Germany)

The Ecoflex® film is placed onto the final layer of the glass scrim, the supply ducts and evacuation ducts are produced and attached, and the infusion process is initiated.

### Production Conditions:

Infusion temperature: about 40° C.
Curing step 1: about 50° C. (5 h)
Curing step 2: about 70° C. (7-10 h)

Directly after curing step 1, air is admitted, and the vacuum film is removed by peeling from the surface, the temperature of which is 50° C. The complete hardening of the GRP sheet then takes place in the second curing step (also termed conditioning step).

### Example 2

Production of a GRP sheet by the vacuum infusion process, and use of Ecovio® film to produce the vacuum bag.

### Material:

Infusion resin: RIM 135 (Momentive) (100 parts by weight)
Infusion hardener: RIM 137i-134 (Momentive)(30 parts by weight)
Glass scrim: Biaxial layer, OFC, 821 g/m², 635 mm
Number of glass scrims: 8
Release agents: Mono Coat 1001 W (water-thinnable; ChemTrend, Maisach, Germany)

The Ecovio® film is placed onto the final layer of the glass scrim, the supply ducts and evacuation ducts are produced and attached, and the infusion process is initiated.

### Production Conditions:

Infusion temperature: about 40° C.
Curing step 1: about 50° C. (5 h)
Curing step 2: about 70° C. (7-10 h)

Directly after curing step 1, air is admitted, and the vacuum film is removed by peeling from the surface, the temperature of which is 50° C. However, the elasticity of this film was so great that it was difficult to remove, and residues sometimes remained. The complete hardening of the GRP sheet then takes place in the second hardening step.

When the GRP sheet is produced in example 1 by means of an Ecoflex® film, the vacuum infusion film can be removed from the sheet without leaving any residue. The Ecovio® film withstands a vacuum infusion process but cannot be removed from the GRP surface without leaving a residue. This is not possible without the use of a surface treatment via, for example, a release agent, e.g. Frekote NC 55 of a nanoscale plasma layer.

1-4. (canceled)

5. A process for producing fiber-reinforced plastics or fiber-reinforced plastics components by means of vacuum infusion, the process comprising:
(a) optionally treating a heatable mold with a release agent,
(b) introducing a fiber material and optionally other reinforcing material into the mold,
(c) placing into the mold one or more hoses for supply of a liquid mixture comprising at least one resin and at least one hardener reactive toward the resin,
(d) applying a plastics film that is effective to provide airtight sealing of the mold, and
(e) extracting air between the mold and the plastics film, whereupon the resultant vacuum sucks the liquid mixture through the hoses into the mold and the fiber material and the optionally other reinforcing material is saturated, and then
(f) curing the liquid mixture to form the fiber-reinforced plastics or plastics component,
wherein the plastics film used in step (d) is a biodegradable plastics film.

6. The process according to claim 5, where the biodegradable plastics film is composed of a copolyester that is synthesized from aliphatic and aromatic monomers.

7. The process according to claim 6, where the aliphatic and aromatic monomers are selected from the group consisting of: aliphatic diols having from 2 to 8 carbon atoms; aliphatic dicarboxylic acids having from 3 to 8 carbon atoms, and their anhydrides, esters, or halides; and aromatic dicarboxylic acids, and their anhydrides, esters, or halides.

8. The process according to claim 7, where the synthesis of the copolyester uses other monomers selected from the group of the triols, tetraols, tricarboxylic acids, and tetracarboxylic acids.

9. The process according to claim 5, wherein the liquid mixture of resin and hardener comprises an epoxy resin and an amine hardener.

10. The process according to claim 9, where the epoxy equivalent weight of the epoxy resin is from 150 to 200 g/equivalent and the amine number of the amine hardener is from 350 to 750 mg KOH/g.

11. The process according to claim 5, wherein the plastics component involves the rotor blade of a windpower system or aircraft parts or helicopter parts.

12. The process according to claim 5, wherein the curing takes place in two stages during process step (f) and the plastics film is removed after the first stage of curing.

13. The process according to claim 12, where the liquid mixture of resin and hardener comprises an epoxy resin and an amine hardener and the first stage of curing takes place at a temperature in the range from 45 to 55° C., and the second stage takes place at a temperature in the range from 60 to 80° C.
